(19) United States
(12) Patent Application Publication
(10) Pub. No.: US 2021/0316425 A1
(43) Pub. Date: Oct. 14, 2021

(54) Fixation Structure of Sleeve Tool

(71) Applicants: Shih-Ju LIN, Taichung City (TW); Chung-Shu CHANG, Taichung City (TW)

(72) Inventors: Shih-Ju LIN, Taichung City (TW); Chung-Shu CHANG, Taichung City (TW)

(21) Appl. No.: 16/903,074

(22) Filed: Jun. 16, 2020

(30) Foreign Application Priority Data
Apr. 14, 2020 (TW) 109204315

(51) Int. Cl. B25B 23/00

(52) U.S. Cl. CPC B25B 23/0014

(57) ABSTRACT

A fixation structure of a sleeve tool is provided and includes a universal joint and a universal socket. The universal joint has a surface and a universal joint hole thereunder. The universal joint hole holds therein a spring and a ball. The universal joint has a radial length including a distance by which the ball protrudes from the surface. The universal socket has a connection hole for receiving and engaging with the universal joint and has an inner side. A recess is disposed under the inner side of the universal socket. The connection hole has a hole diameter. The ratio of the radial length to the hole diameter is greater than 0.902 to prevent the ball from retracting completely into the recess even when a user pulls the universal joint 20 by hand, thereby preventing the universal joint from escaping from the connection hole of the universal socket.

### BACKGROUND OF THE INVENTION

### 1. Technical Field

The present disclosure relates to the technical field of hand tools and, more particularly, to a fixation structure of a sleeve tool.

### 2. Description of Related Art

Conventional hand tools each essentially comprise a handle and a driving portion. The driving portions come in different designs, depending on applications. For example, the driving portion of a conventional hand tool for fixing a hexagon nut in place includes a sleeve, whereas the handle of the conventional hand tool is rod-shaped. The handle and the driving portion together take on a T shape, so as to fit the sleeve around the nut and thereby rotate the nut.

Referring to FIG. 1, a sleeve tool 10 capable of bending is commercially available. The sleeve tool 10 has a plurality of link rods 11. One end of each link rod 11 has a universal joint 111. The other end of each link rod 11 has a universal socket 112. Each universal joint 111 is connected to a corresponding universal socket 112, thereby connecting the plurality of link rods 11 in series.

To start using the sleeve tool 10, a user fits the universal socket 112 at the free end around the nut. Since the universal joints 111 and universal sockets 112 of the link rods 11 are connected in series, the link rods 11 can bend relative to each other; consequently, the sleeve tool 10 has a longer range than the conventional hand tools.

Referring to FIG. 2 and FIG. 3, the universal joint 111 is substantially cubic in shape. The universal joint 111 has a surface and has a universal joint hole 113 under the surface. The universal joint hole 113 holds therein a spring 12 and a ball 13. The universal socket 112 has an inner side and has a recess 114 under the inner side. When the universal joint 111 is disposed in the universal socket 112, the ball 13 is pushed by the spring 12 to thereby abut against the recess 114, thereby fixing the ball 13 to the recess 114.

To allow the user to connect and separate the link rods 11, requirements described below must be fulfilled. A conventional drive socket set includes drive sockets with drive holes, which come in different dimensions, for example, 1/10″, ¼″, and ½″. The description below is exemplified by ¼″ drive socket. Both the spring 12 and the ball 13 are mounted in place in the universal joint hole 113. The ball 13 protrudes 5.8 mm from the universal joint 111. The hole diameter of the universal socket 112 is 6.54 mm. When the universal joint 111 is mounted in place in the universal socket 112, a compression distance 14 of around 0.63 mm is reserved between the surface of the universal joint 111 and the inner side of the universal socket 112. A universal joint radial length is defined as the distance by which the ball 13 protrudes from the surface of the universal joint 111. A universal socket radial length is defined as the hole diameter of the universal socket 112. The universal socket radial length is slightly greater than the universal joint radial length. Therefore, when the universal joint 111 is mounted in place in the universal socket 112, the compression distance 14 is reserved between the surface of the universal joint 111 and the inner side of the universal socket 112. As a result, not only can the user insert the universal joint 111 into the universal socket 112 by hand, but the user can also connect and separate the universal joint 111 and the universal socket 112 by hand, provided that the ratio of the universal joint radial length to the hole diameter of the universal socket 112 is less than 0.902.

Conversely, if the ratio of the universal joint radial length to the hole diameter of the universal socket 112 is greater than 0.902, the user cannot connect and separate the universal joint 111 and the universal socket 112 by hand. Therefore, the sleeve tool 10 capable of bending is intrinsically unstable, because the link rods 11 can be separated by the user by hand.

Therefore, it is imperative to provide a bendable sleeve tool 10 whose link rods are inseparable by hand.

### BRIEF SUMMARY OF THE INVENTION

It is an objective of the present disclosure to overcome a drawback of the prior art, that is, conventional sleeve tools capable of bending are intrinsically unstable, because their link rods can be separated by a user by hand.

In order to achieve the above and other objectives, the present disclosure provides a fixation structure of a sleeve tool, comprising a universal joint and a universal socket.

The universal joint has a surface and has a universal joint hole under the surface. The universal joint hole holds therein a spring and a ball. The universal joint has a radial length which includes a radial length by which the ball protrudes from the surface.

The universal socket has a connection hole adapted to receive and engage with the universal joint. The universal socket has an inner side and has a recess under the surface. The connection hole has a hole diameter. The ratio of the radial length to the hole diameter is greater than 0.902.

In a preferred embodiment, the hole diameter is defined as the distance between two opposing inner sides of the connection hole.

In a preferred embodiment, a recess is disposed under the inner side and adapted to engage with the ball and thereby fix the ball in place.

In a preferred embodiment, the ratio of the radial length to the hole diameter ranges from 0.902 to 1.

Since the ratio of the radial length to the hole diameter is greater than 0.902, a user pulls the universal joint by hand to enable the ball to protrude further from the surface of the universal joint but not to retract completely into the recess, and thus the universal joint is prevented from escaping from the connection hole of the universal socket.

### BRIEF DESCRIPTION OF THE SEVERAL VIEWS OF THE DRAWINGS

FIG. 1 (PRIOR ART) is a perspective view of a sleeve tool capable of bending.

FIG. 2 (PRIOR ART) is a cross-sectional view of the assembled sleeve tool capable of bending.

FIG. 3 (PRIOR ART) is a cross-sectional view, taken from another view angle, of the assembled sleeve tool capable of bending.

FIG. 4 is a cross-sectional view of a preferred embodiment of the present disclosure.

FIG. 5 is a cross-sectional view of a preferred embodiment of the present disclosure from another view angle.

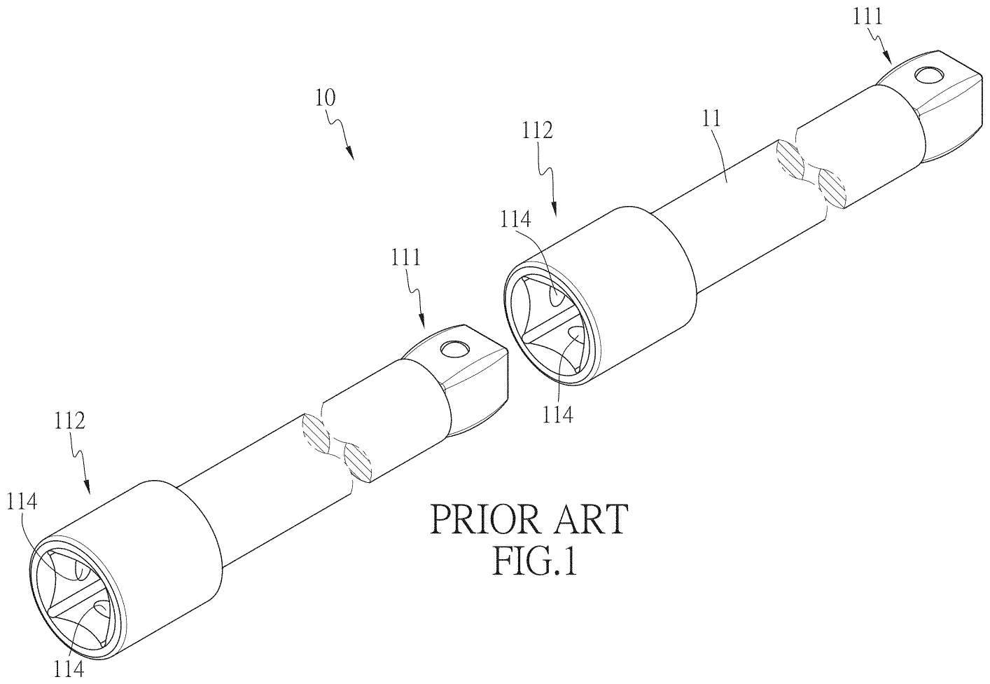

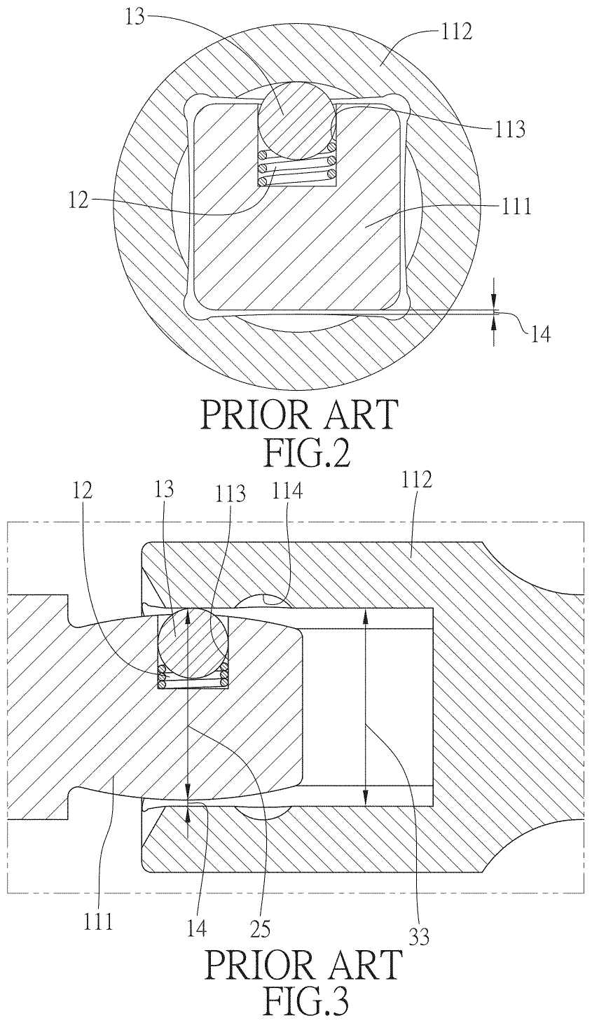

### DETAILED DESCRIPTION OF THE INVENTION

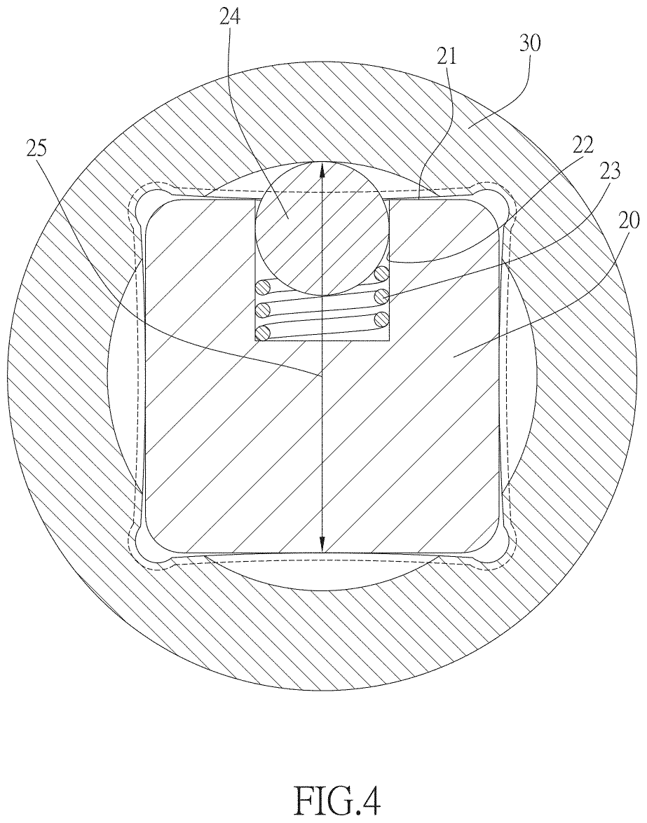

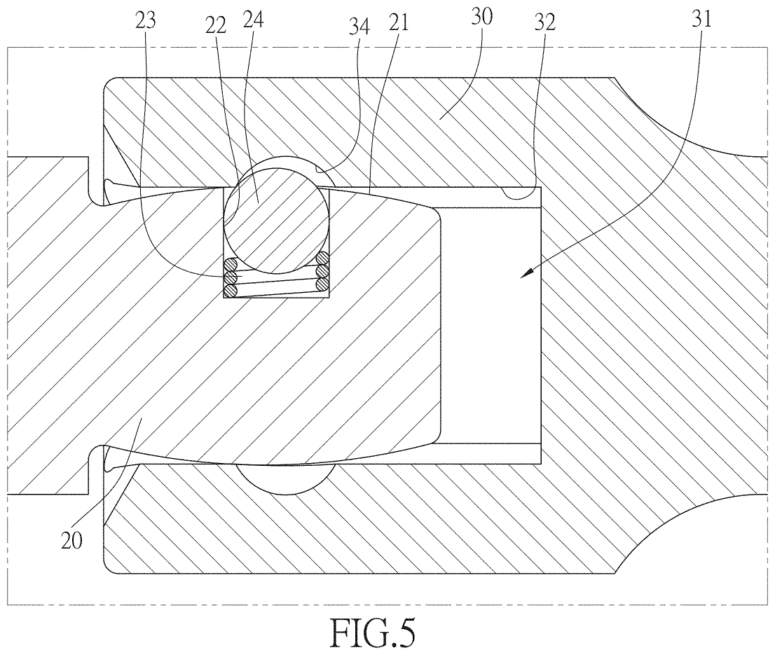

Referring to FIG. 4 and FIG. 5, the present disclosure provides a fixation structure of a sleeve tool, which essentially comprises a universal joint 20 and a universal socket 30.

The universal joint 20 is substantially cubic in shape. The universal joint 20 has a surface 21 and has a universal joint hole 22 under the surface 21. The universal joint hole 22 holds therein a spring 23 and a ball 24. The spring 23 has one end abutting against the bottom side of the universal joint hole 22. The spring 23 has the other end abutting against the ball 24 to push the ball 24, such that the ball 24 protrudes from the surface 21. The universal joint 20 has a radial length 25 which includes a distance by which the ball 24 protrudes from the surface 21. In this embodiment, the depth of the universal joint hole 22 which holds therein the spring 23 and the ball 24 is relatively reduced, such that the ball 24 is pushed by the spring 23 and thus protrudes further from the surface 21, thereby increasing the radial length 25.

A connection hole 31 is disposed under the end side of the universal socket 30 and adapted to receive and engage with the universal joint 20. The universal socket 30 has an inner side 32 which surrounds the connection hole 31. A hole diameter 33 is defined as the distance between two opposing inner sides 32 in the connection hole 31. The ratio of the radial length 25 to the hole diameter 33 is greater than 0.902, such that the universal joint 20 cannot escape from the connection hole 31 of the universal socket 30. A recess 34 is disposed under each inner side 32 and adapted to engage with the ball 24 and thereby fix the ball 24 in place.

In this embodiment, the hole diameter 33 is 6.54 mm, whereas the radial length 25 is 5.9 mm. The ratio (X) of the radial length 25 to the hole diameter 33 is calculated as follows:

radial length 5.9 mm: hole diameter 6.54 mm=5.9/6.54=0.90214

Therefore, the ratio (X) of the radial length 25 to the hole diameter 33 is 0.90214. Since the ratio of the radial length 25 to the hole diameter 33 is greater than the 0.902, the universal joint 20 cannot be mounted in place in the connection hole 31 of the universal socket 30 by hand but must be pressed into the connection hole 31 of the universal socket 30 with a hydraulic machine or pressing machine. After being fitted to each other with the hydraulic machine or pressing machine, the universal joint 20 and the universal socket 30 cannot be separated by hand. Therefore, the present disclosure is effective in ensuring that the universal joint 20 and the universal socket 30 cannot be separated by hand.

Furthermore, the ratio of the radial length 25 to the hole diameter 33 must be less than 1; thus, the ratio of the radial length 25 to the hole diameter 33 must range from 0.902 to 1 in order to ensure that the universal joint 20 and the universal socket 30 cannot be separated by hand.

In the second embodiment, the radial length 25 of the connection hole 31 is reduced, such that the ratio of the radial length 25 to the hole diameter 33 is greater than 0.902.

The structural features and connections thereof in a preferred embodiment of the present disclosure are described above. The usage and achievable advantages of the present disclosure are described below.

Referring to FIG. 5, the universal joint 20 is mounted in place in the connection hole 31 of the universal socket 30 with the hydraulic machine or pressing machine, such that the ball 24 is engaged with and fixed to the recess 34. The spring 23 abuts against the ball 24, so as to fix the universal joint 20 and the universal socket 30 in place.

Since the ratio of the radial length 25 to the hole diameter 33 is greater than 0.902, a user pulls the universal joint 20 by hand to enable the ball 24 to protrude further from the surface 21 of the universal joint 20 but not to retract completely into the recess 34, and thus the universal joint 20 is prevented from escaping from the connection hole 31 of the universal socket 30.

What is claimed is:

1. A fixation structure of a sleeve tool, comprising:
a universal joint having a surface and having a universal joint hole under the surface, the universal joint hole holding therein a spring and a ball, wherein the universal joint has a radial length which includes a distance by which the ball protrudes from the surface; and
a universal socket having a connection hole adapted to receive and engage with the universal joint and having an inner side, wherein a recess is disposed under the inner side of the universal socket, the connection hole having a hole diameter, and a ratio of the radial length to the hole diameter is greater than 0.902.

2. The fixation structure of a sleeve tool according to claim 1, wherein the hole diameter is defined as a distance between two opposing inner sides in the connection hole.

3. The fixation structure of a sleeve tool according to claim 1, wherein a recess is disposed under the inner side and adapted to engage with the ball and fix the ball in place.

4. The fixation structure of a sleeve tool according to claim 1, wherein the ratio of the radial length to the hole diameter ranges from 0.902 to 1.
